(19) United States
(12) Patent Application Publication
(10) Pub. No.: US 2004/0073490 A1
(43) Pub. Date: Apr. 15, 2004

(54) Dynamic service fulfillment

(76) Inventors: Baiju Shah, Palatine, IL (US); Ryan C. Horner, Evanston, IL (US); Jaimin A. Soni, Schaumburg, IL (US)

Correspondence Address: VEDDER PRICE/ACCENTURE, 222 NORTH LASALLE STREET, CHICAGO, IL, 60601, US

(21) Appl. No.: 10/271,146

(22) Filed: Oct. 15, 2002

(51) Int. Cl. G06F 17/60

(52) U.S. Cl. 705/26

(57) ABSTRACT

With the permission of a targeted recipient, a service provider obtains access to schedule information of a targeted recipient and, based on the schedule information determines scheduled availability of the targeted recipient to accept fulfillment of the service. Additionally, permission-based access to location information of the targeted recipient is obtained and a location of the targeted recipient is determined based on the location information. Thereafter, fulfillment of the service is directed to the location of the targeted recipient. At the time of service fulfillment, service personnel are provided access to location and identification information of the targeted recipient such that fulfillment of the service is further enhanced. In one embodiment of the present invention, package delivery may be automatically scheduled or rescheduled in this manner. In this manner, service providers can efficiently carry out fulfillment of their services while simultaneously accommodating schedules and preferences of targeted recipients of their services.

### FIELD OF THE INVENTION

The present invention relates to fulfillment of a service and, in particular, to a technique for dynamic fulfillment of such a service using permission-based access to information of a targeted recipient of the service.

### BACKGROUND OF THE INVENTION

In many service based industries significant expense is often incurred in attempting to schedule fulfillment of a given service directed to a targeted recipient. Perhaps more significantly, otherwise unpredictable or unavoidable schedule changes that prevent fulfillment of the service cause even further expense to be incurred on the part of the service provider, and are often a source of frustration for the targeted recipient. For example, in the package delivery arena, on-time delivery of packages is crucial to the success of a package delivery service. Typically, the delivery company will attempt to deliver an item to the targeted recipient at the recipient's home. If no one is available at the recipient's home to take delivery, the delivery company will again attempt to deliver the item at a later date, or will request the targeted recipient to contact the delivery company. However, such missed deliveries often result in significant storage and rescheduling costs to the delivery company, and often represent a great inconvenience and source of dissatisfaction to the parties waiting to receive their packages.

Today, service companies have no mechanism to automatically determine availability of a targeted recipient of their service in order to maximize the likelihood that the service will be fulfilled in an efficient manner. Therefore, it would be advantageous to provide a technique whereby service providers can dynamically schedule and fulfill services to targeted recipients. Preferably, such a technique should be capable of being performed substantially automatically, with minimal loss of privacy to targeted recipients.

### BRIEF SUMMARY OF THE INVENTION

The present invention provides a technique for fulfilling a service in a dynamic fashion. In particular, the present invention allows service providers to dynamically schedule service fulfillment based on permission-based access to various components of a targeted recipient's information. With the permission of the targeted recipient, the service provider obtains access to schedule information of a targeted recipient and, based on the schedule information determines scheduled availability of the targeted recipient to accept fulfillment of the service. In another embodiment of the present invention, permission-based access to location information of the targeted recipient is obtained and a location of the targeted recipient is determined based on the location information. Thereafter, fulfillment of the service is directed to the location of the targeted recipient. In some instances, the service provider may offer the ability to schedule service fulfillment in this manner as an option available to the targeted recipient for a fee. In those instances, further permission may be obtained by the service provider to access account information of the targeted recipient such that payment of the fee is secured. At the time of service fulfillment, service personnel are provided access to location and identification information of the targeted recipient such that fulfillment of the service is further enhanced. In a presently preferred embodiment, a computer implemented dynamic service assistant is employed to obtain the necessary permissions, access the required information, and coordinate the scheduling of the service fulfillment. In a particularly advantageous application of the present invention, package delivery may be automatically scheduled or rescheduled based on availability of a targeted recipient of a package. In this manner, the present invention allows service providers to more efficiently carry out fulfillment of their services and at the same time accommodate the particular schedules and preferences of targeted recipients of their services.

### BRIEF DESCRIPTION OF THE DRAWINGS

FIG. 1 is a block diagram of a communication system in accordance with an embodiment of the present invention.

FIG. 2 is a flowchart of a method in accordance with an embodiment of the present invention.

FIGS. 3 and 4 are schematic illustrations of communications between a dynamic delivery assistant/delivery service, a targeted recipient, an information repository and service personnel in accordance with an exemplary embodiment directed to package delivery in accordance with the present invention.

FIGS. 5-15 illustrate exemplary displays provided to a targeted recipient in accordance with the embodiment of FIG. 3.

FIG. 16 illustrates an exemplary display provided to delivery personnel in accordance with the embodiment of FIG. 4.

### DETAILED DESCRIPTION OF THE INVENTION

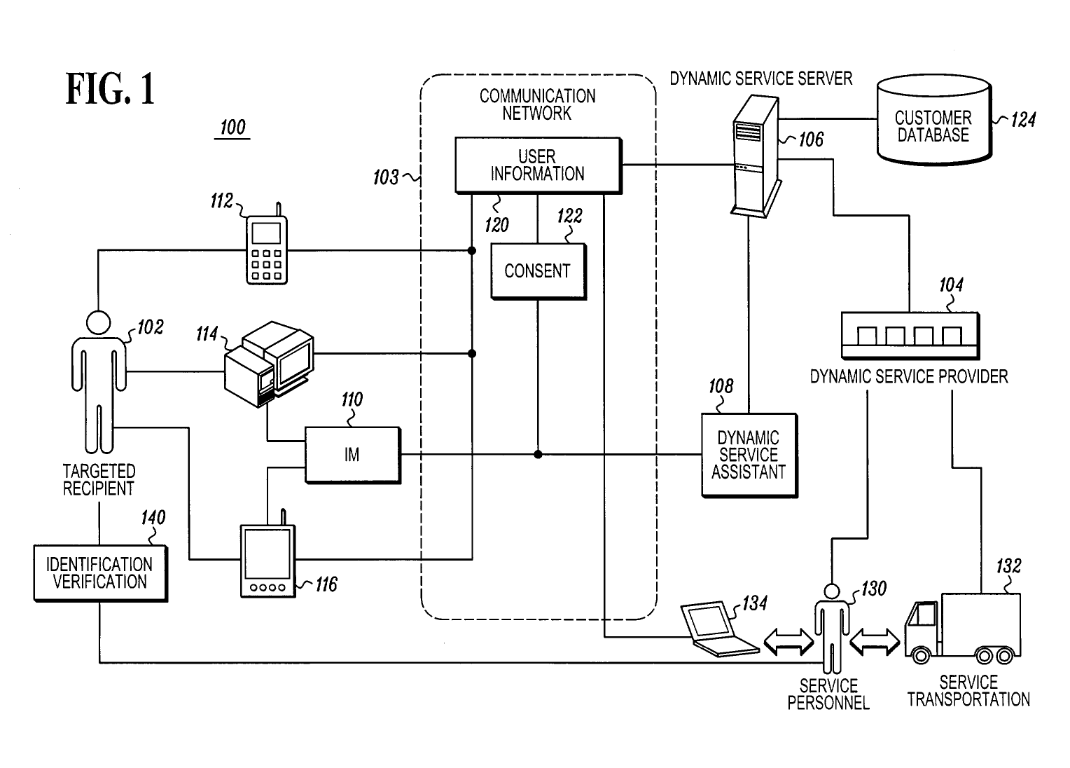

The present invention may be more fully described with further reference to FIGS. 1-16. Referring now to FIG. 1, a communication system 100 in accordance with the present invention is illustrated. In particular, the communication system 100 comprises a targeted recipient 102 in communication with a service provider 104 via a communication network 103. As used herein, a service provider comprises any entity that provides service of any type, on either a commercial (i.e., fees charged) or non-commercial basis, for the benefit of others, which service requires involvement of a targeted recipient of the service for fulfillment. In a particular embodiment described below, the service provider comprises a package delivery service. Those having ordinary skill in the art will recognize that many other types of service providers could benefit from application of the present invention.

The communication network 103 preferably comprises a publicly available network such as the Internet and/or World Wide Web. However, the communication network may comprise a private communication network, such as a company's intranet or extranet, or may comprise a combination of public and private network elements as a matter of design choice.

As shown, the service provider 104 is coupled to the communication network 103 and an information repository 120 via a service provider server 106, and to the targeted recipient 102 via the communication network 103 and a dynamic service assistant 108. In a presently preferred embodiment, the dynamic service assistant 108 comprises an automated, computer-implemented process capable of sustaining limited communications with the targeted recipient 102 using instant messaging protocols, i.e., a so-called instant message chatbot. This is further illustrated in FIG. 1 where the dynamic service assistant 108 communicates with the targeted recipient 102 via an instant messaging channel 110 coupled to either or both of a personal computer 114 and a personal digital assistant or palm top computer 116 associated with the targeted recipient. The establishment of instant messaging channels 110 between such devices is well known in the art and need not be described in greater detail herein. The present invention is not limited, however, to the use of instant messaging communication channels for communications between the dynamic service assistant 108 and the targeted recipient 102. For example, the dynamic service assistant 108 could incorporate voice synthesis and voice recognition elements such that it is able to communicate with the targeted recipient using a voice communication channel and associated protocols. Those having ordinary skill in the art will recognize that further alternatives within the scope of the present invention are possible in this regard.

As alluded to above, a variety of devices may be used by targeted recipients 102 to communicate not only with the dynamic service assistant 108, but also with the communication network 103 and, in particular, the information repository 120 comprising each targeted recipient's information. In addition to the computer devices 114, 116 mentioned above, the targeted recipients 102 can communicate with the communication network 103 via a wireless device 112 such as a cellular telephone. In order to differentiate between targeted recipients, each targeted recipient has a unique identification associated with him or her. In a presently preferred embodiment, discussed in further detail below, the unique identification possessed by each targeted recipient is a Passport User Identification (PUID) used in conjunction with the .NET My Services information management platform offered by Microsoft Corporation. One of the services offered by the .NET My Services platform includes a Presence service which, among other things, tracks the current mode of accessibility of a given person, i.e., which device 112-116 is appropriate and/or preferred for communicating with the person at any give time.

Within the communication network 103, an information repository 120 is provided for the storage of user (targeted recipient) information used in accordance with the present invention to facilitate the dynamic fulfillment of services. In implementation, the information repository 120 is implemented as one or more computer-based interface and storage servers. The user information stored within the repository 120 at least comprises schedule information, location information, account information and identification information corresponding to and controlled by various targeted recipients. The schedule information comprises information regarding the planned activities, including time and location, of a given user. In a preferred embodiment, the schedule information is embodied as a computer-accessible calendar. Related to the schedule information, the location information comprises data that may be used to identify a physical location of a user. In the context of the present invention, the location information may be more general in nature as found in the schedule information. For example, an entry in a user's schedule information may state “1:00 PM—staff meeting in Chicago office at 1 Main Street.” In this case, it is understood that the user is planning to be at his or her office at that time. In addition to this type of location information, the present invention may make use of more accurate real-time or near-real time location information, such as data of the type available through the use of global positioning satellite (GPS) systems. The account information preferably comprises financial information regarding the targeted recipient such as credit card information and the like. The identification information comprises information that allows the particular user with whom it is associated to have his or her identity authenticated. For example, the identification information may comprise an image of the user, as well as other information about the user such as his/her job affiliation, title, biometric data, digital signature or any other information that could be used to authenticate the identity of a person. In a particular embodiment of the present invention, described below, the various types of user information stored within the repository 120 are managed using the so-called .NET My Services platform offered by Microsoft Corporation. It is understood, however, that the physical location and implementation of the information repository 120 is susceptible to a variety of different implementations. For instance, a user's permission-based calendar could reside within an employer's private communication network, within servers maintained by a publicly accessible service such as Yahoo or even within a remote, mobile device such as a cell phone. At the same time, the user's permission-based location information could be residing with networks maintained by the user's wireless carrier or directly on the user's cell phone. Thus, in the case, for example, where a user's calendar and location information is stored on the user's cell phone (or with the wireless carrier), all the necessary context is available to the service fulfiller. In this light, it is evident that the present invention may be implemented with only relatively slight modifications to currently available infrastructure.

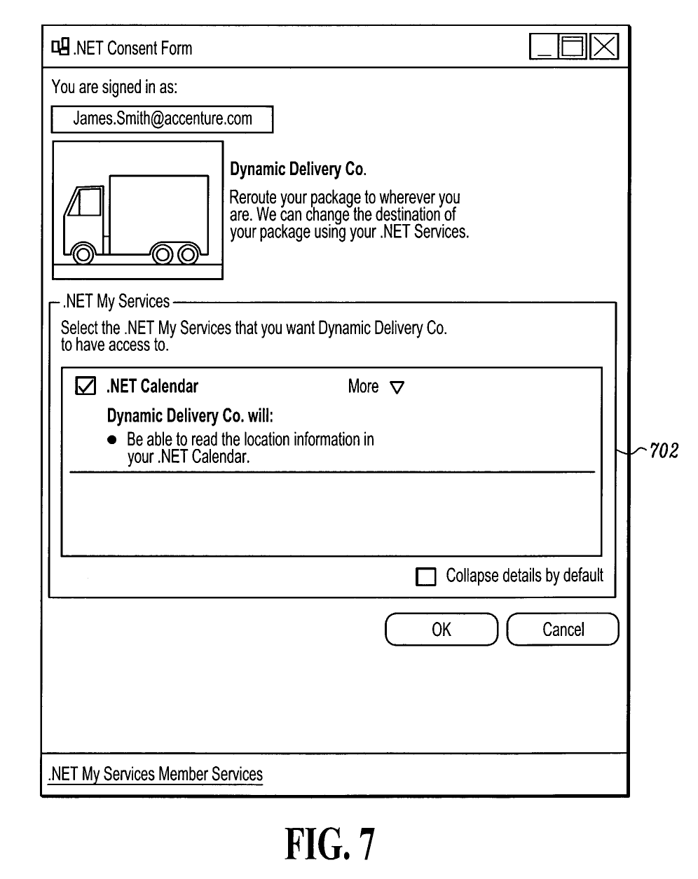

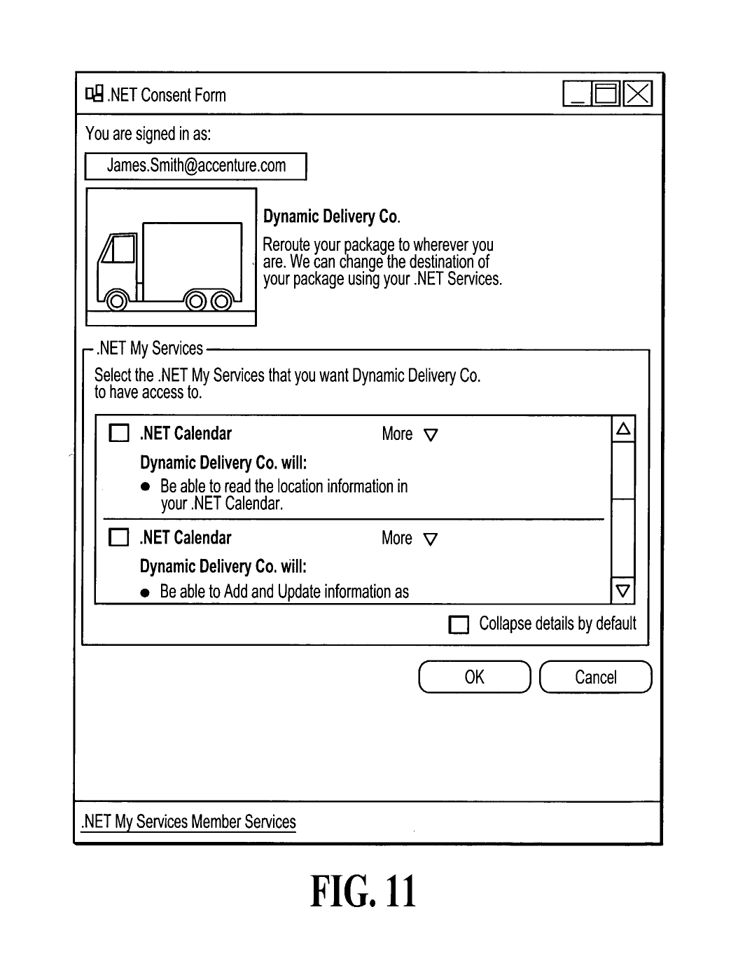

A particular feature of the present invention is that service providers (via, for example, the service provider server 106) may access user information within the information repository 120 only with the permission of the targeted recipient. To this end, a consent mechanism 122 is provided whereby a targeted recipient may grant permission to the service provider 104 (preferably via the dynamic service assistant 108) to access various portions of the targeted recipient's information. The consent mechanism 122 allows the targeted recipient to specify exactly which portions of his or her information the service provider 104 is being granted access. Once again, a particular example of a consent mechanism 122 used in conjunction with Microsoft's .NET My Services is described in further detail below with particular reference to FIGS. 7 and 11.

As further shown in FIG. 1, the system 100 comprises service personnel 130 and, optionally, service transportation 132 in communication with the dynamic service provider 104. The nature of the service personnel 130 and corresponding service transportation 132, if used, is necessarily dependent upon the nature of the service being provided and will likely vary between industries. In any event, the service provider 104 may communicate with the service personnel 130 and service transportation 132 using conventional techniques, e.g., a land mobile radio system. In a presently preferred embodiment, the service personnel 130 are each equipped with a portable or wearable computer 134 that is used to communicate, in part, with the information repository 120 as well as the service provider 104. Alternatively, the portable or wearable computer 134 may comprise the only communication device used by each of the service personnel, e.g., the need for a conventional land mobile radio system could be eliminated. A particular example of a suitable computer 134 is the Xybernaut computer. In order to fulfill a given service, the service personnel 130 establishes contact with the targeted recipient based on scheduling established by the dynamic service assistant 108, as described in further detail below, and, optionally, based on location information obtained from the information repository 120 via his/her wearable computer 134. Once in contact with the targeted recipient, the service personnel 130 engages in identification verification 140 as also described in further detail below. To this end, the service personnel 130, via his/her wearable computer 134, accesses identification information of the targeted recipient stored in the information repository 120. In this manner, the potential for fraudulent fulfillment of a given service, i.e., someone pretending to be the targeted recipient, is substantially minimized.

Finally, a customer database 124 is provided, coupled to the dynamic service server 106. The customer database 124 comprises any user-related information regarding the service provider's interaction with customers but not otherwise available via the information repository 120. Such information may comprise, for example, account setup information, account history information, billing information, etc.

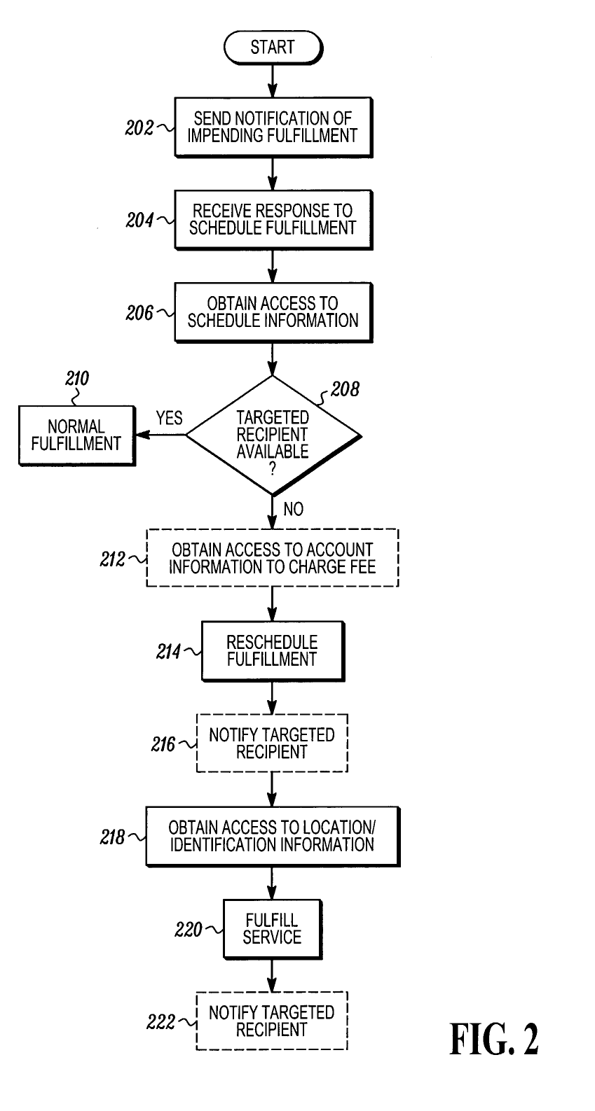

Referring now to FIG. 2, a flowchart illustrating a method in accordance with the present invention is illustrated. In a presently preferred embodiment, the method illustrated in FIG. 2 at blocks 202-216 is implemented using a dynamic service assistant as described above. Processing and steps described relative to blocks 218-222, on the other hand, are carried out by appropriate service personnel preferably equipped with portable or wearable computers or the like. Those portions of the method illustrated in FIG. 2 attributed to the dynamic service assistant are preferably implemented using software routines stored on machine-readable media and executed by an appropriate processing platform, such as a server or other computer-based device as known in the art. Furthermore, although not explicitly shown in FIG. 2, the discussion below describes interactions by the targeted recipient with the dynamic service assistant as well as the service personnel.

At block 202, a service provider, via a dynamic service assistant, sends a notification to a targeted recipient of impending fulfillment of a service. In order to send the notification to the targeted recipient, it is assumed that service provider possesses, or can obtain, information regarding how to contact the targeted recipient. In sending the notification, the service provider may or may not include an intended time and location of service fulfillment. For example, where the service provider comprises a package delivery service, the package delivery service may intend to drop a package off with the targeted recipient at the targeted recipient's house on a given date. Note that the notification can be sent to the targeted recipient through any of a number of given channels. Referring to FIG. 1, the notification could be sent to the targeted recipient 102 via the targeted recipient's personal computer 114, palm computer 116 or cellular telephone 112. The particular form and content of the notification is necessarily dependent upon the nature of the service to be fulfilled as well as the channel through which it is to be delivered and, as such, is a matter of design choice.

Regardless of the notification's particular content or the manner in which it is sent, the targeted recipient may respond to the notification by requesting that the dynamic delivery assistant attempt to schedule a time and location for fulfillment of the service based on the targeted recipient's schedule information. This response is received by the dynamic service assistant at block 204 and, in response, the dynamic service assistant obtains access to schedule information of the targeted recipient at block 206. To this end, the dynamic service assistant must either already be in possession of, or must seek out, permission from the targeted recipient to obtain access to the schedule information. Assuming that the dynamic delivery assistant is able to obtain access to the schedule information, processing continues at block 208 where the dynamic service assistant determines scheduled availability of the targeted recipient. Where the service provider had an intended time and location of service fulfillment already established, the dynamic service assistant determines, based on the schedule information made available to the dynamic service assistant, whether the targeted recipient is available at the intended time and location. If so, processing continues at block 210 where normal fulfillment of the service is achieved at the intended time and location.

However, if the schedule information indicates that the targeted recipient is not available, the dynamic service assistant can determine whether the targeted recipient desires to reschedule fulfillment of the service. As mentioned above, the option to dynamically reschedule fulfillment of the service may be offered as an option to the targeted recipient for which the targeted recipient will pay a fee. In this case, processing may optionally continue at block 212 where the dynamic service assistant obtains permission-based access to account information of the targeted recipient. In this manner, the dynamic service assistant can assure that payment has been or will be secured prior to attempting to reschedule fulfillment of the service.

Regardless whether there is a fee charged for the ability to reschedule fulfillment of the service, and assuming that the targeted recipient desires to reschedule fulfillment, processing continues at block 214 where the dynamic service assistant reschedules fulfillment of the service. To this end, the dynamic service assistant may rely on previous permission to access schedule information of the targeted recipient or, in a preferred embodiment, may again request access to the schedule information for the purpose of rescheduling fulfillment. Rescheduling is accomplished when the dynamic service assistant identifies a suitable block of time and/or location for fulfillment of the service. Of course, identification of such a suitable block depends upon the nature of the service to be fulfilled; a service as simple as delivery of a package requires relatively little time and can be accomplished in a number of locations, whereas a more personal service, such as meeting with a tailor, a doctor or an insurance claims adjuster/estimator may be more time intensive and would likely require a more private setting. In a current embodiment, identification of a suitable time is based on the ability of the service provider to fulfill the service (i.e., when and where would the service provider be able to fulfill the service in a cost effective manner). However, it is anticipated that preferences of the targeted recipient regarding fulfillment of services (e.g., will not accept fulfillment during work hours at the office, only during times when nothing else is schedules, etc.) may be incorporated into the determination of a suitable time and place for fulfillment.

Assuming that fulfillment of the service has been successfully rescheduled, the targeted recipient may be optionally notified at block 216. In a preferred embodiment, such notification is sent to the targeted recipient via a preferred communication channel as designated by preference information (the permission to access such information having been previously obtained, for example, at block 206 or block 214) stored with the targeted recipient's information in the repository. Once again, the particular content and form of the notification sent at block 216 is dependent upon the type of service being fulfilled and the channel with which it is delivered.

At the time for fulfilling the service, as determined by the rescheduling performed by the dynamic service assistant, the service employee tasked with fulfilling the service obtains access to location and identification information of the targeted recipient, as shown at block 218. Once again, permission for the service employee (as an agent of the service provider) to access such information of the targeted recipient may be previously granted, as is presently preferred, or may be requested at the time of fulfillment. In any event, the service employee can access the location and identification information via a suitable communication device such as the wearable computer associated with the service employee. In one embodiment of the present invention, the location information comprises GPS data describing the current location of the targeted recipient. In practice, such data may be obtained through the use of GPS enabled devices or other devices capable of providing location data, such as cellular telephones. The identification information allows the service personnel to better identify the targeted recipient. For example, the identification information may comprise an image of the targeted recipient's face thereby allowing the service personnel to more accurately identify the targeted recipient.

In any event, at block 220, the service personnel fulfills the service after finding the targeted recipient based on the location information and, preferably, authenticating identification of the targeted recipient based on the identification information. Various mechanisms for authenticating a persons identity may be used, as described in further detail below. The location information used to locate the targeted recipient may be self-explanatory to the service employee (i.e., a street address) or may require the use of a reference for comparison (i.e., GPS latitude/longitude coordinates). Once the service has been fulfilled, the service personnel notifies the service provider and/or the dynamic service assistant that the service has been fulfilled. In response, at block 222, the dynamic service assistant notifies the targeted recipient of fulfillment of the service using a suitable notification message sent via any suitable channel. In this manner, unauthorized fulfillment of the service may be detected as soon as possible. The notifications provided by the dynamic service assistant can be expanded to include all parties having an interest in the fulfillment of the service and having the necessary permission to be notified. For instance, in the case of package delivery, the sender of the package can also be notified that the package has been delivered.

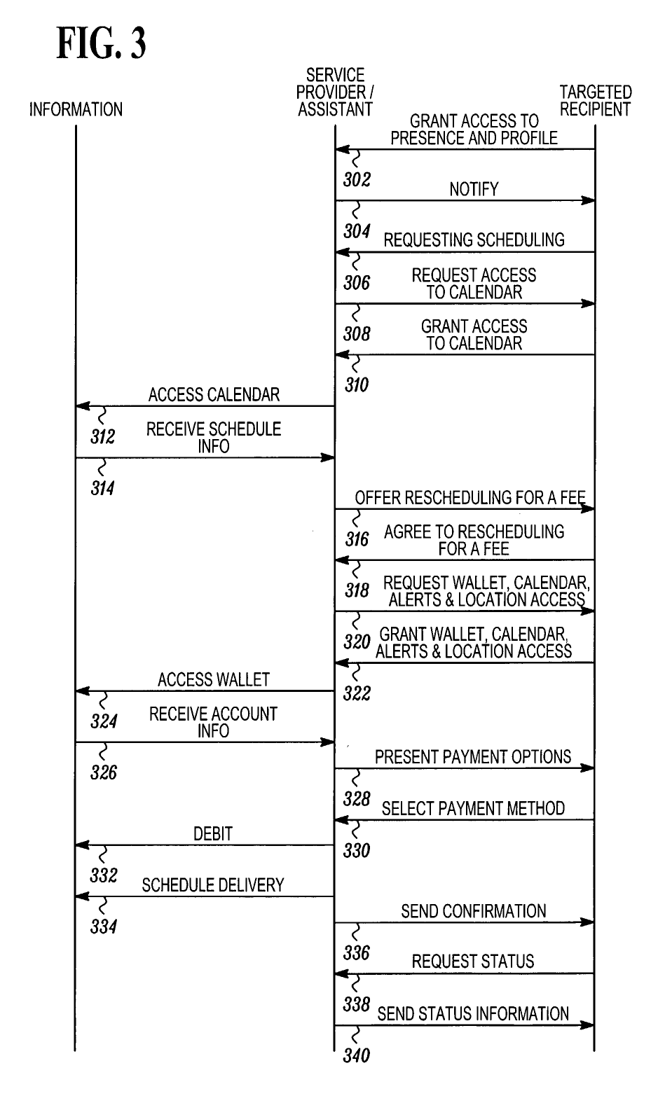

A particular example of the present invention is further described with reference to FIGS. 3-16. In particular, the example illustrated therein relates to a package delivery service. Additionally, the example illustrated in FIGS. 3-16 uses the so-called .NET My Services Platform developed by Microsoft Corporation. .NET My Services is a platform for unifying an individual's data across devices and making the data accessible to the user and to other services in a secure fashion. Organized around individual users, rather than the devices that such users may use, .NET My Services functions to deliver personally relevant information through the Internet to a user, to software running on the user's behalf (e.g., the dynamic service assistant), or to devices working for the user. In implementation, .NET My Services relies on Microsoft's Passport service to provide user identification. The user controls access to and usage of information associated with his or her identity. As designed, .NET My Services platform uses an open access model thereby allowing use with any device, application or service, regardless of the underlying platform, operating system, object model, programming language or network provider. All .NET My Services are XML (Extensible Markup Language) Web services, which are based on the open industry standards of XML and SOAP (Simple Object Access Protocol). The instant example described below is based upon use of the so-called Presence, Profile, Calendar, Wallet, Alerts, and Location services provided by the .NET My Services platform. Although the instant example is described in terms of the .NET My Services platform, it is understood that other information management systems offering similar capabilities may be equally employed. For example, it is believed that the so-called Liberty Alliance Project may deliver competing technology to Microsoft's .NET My Services platform. To the extent that such technology offers some or all of the capabilities described herein, it may serve as an alternative for implementing the present invention.

Referring now to FIG. 3, communications between the dynamic service assistant, targeted recipient and information repository are further illustrated. Once again, the communications illustrated in FIG. 3 are assumed to be implemented based on computer-to-computer type communications achievable through, for example, the Internet and/or World Wide Web. Additionally, in the example of FIG. 3, it is assumed that the targeted recipient (a person, for this example, named “James Smith”) has engaged the services of the package delivery service in order to receive a package.

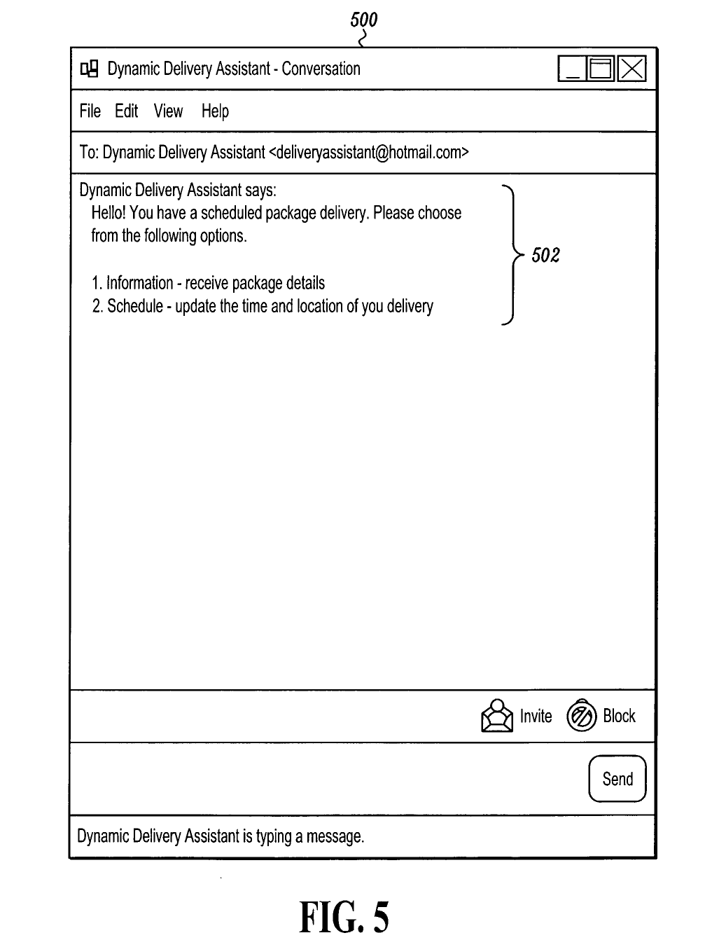

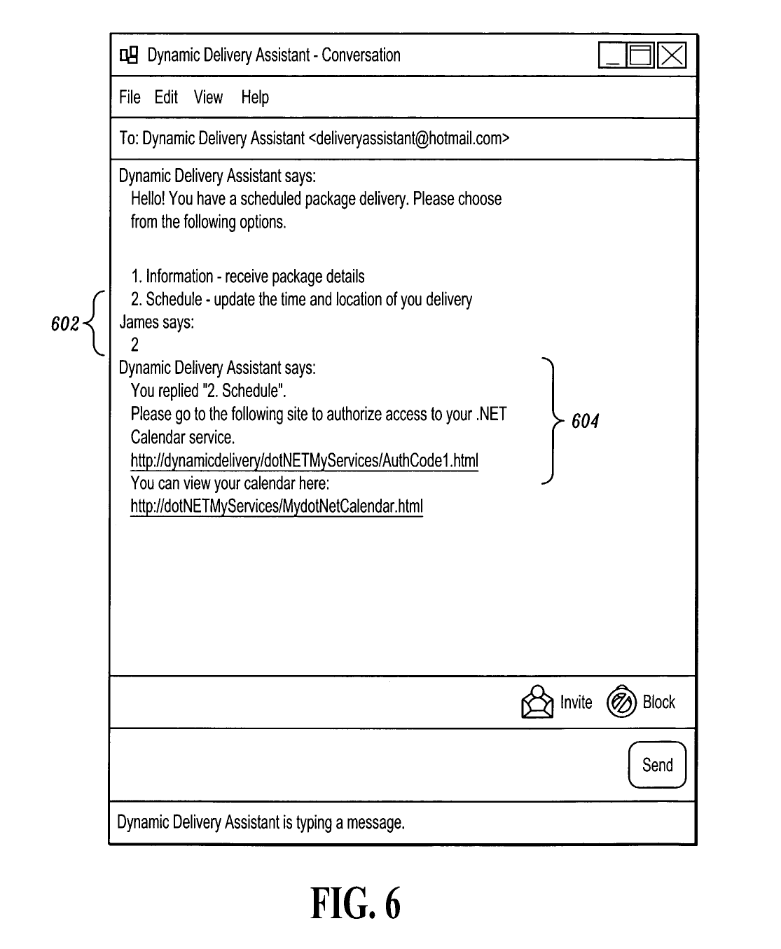

Thus, at step 302, the targeted recipient grants permission for the dynamic service assistant to access information maintained by the targeted recipient's Presence and Profile services. The Presence service maintains information that instructs the dynamic service assistant how to contact the targeted recipient, and the Profile service maintains basic information regarding the targeted recipient, such as the targeted recipient's instant messaging screen name, the targeted recipient's home and work address information, as well as information regarding the best/most appropriate method (phone, instant messaging, email, etc.) to communicate with the targeted recipient. Thereafter, at step 304, when the intended delivery location and time has been determined by the package delivery service, the assistant sends a notification to the targeted recipient. This is further illustrated in FIG. 5 where it is assumed that a preferred channel of communication with the targeted recipient is through an instant messaging conversation 500, as illustrated. Instant messaging communication channels are well known in the art and need not be described in further detail herein. As shown, the dynamic delivery assistant provides a text message 502 allowing the targeted recipient to request scheduling of the delivery at step 306. Such a request is illustrated in FIG. 6 as designated by reference numeral 602 where the targeted recipient selects an option to schedule delivery. In response to the request from the targeted recipient, the dynamic delivery assistant requests access to the targeted recipient's calendar at step 308. This is illustrated in FIG. 6 as designated by reference numeral 604 where the dynamic delivery assistant requests the targeted recipient to access a consent form to provide authorization. In the example shown, the consent form may be accessed by selecting the path designated by a Uniform Resource Locator (URL). An exemplary consent form is further illustrated in FIG. 7 in which the specific permissions being requested are described 702 and where the targeted recipient may agree to provide such access to the dynamic service assistant.

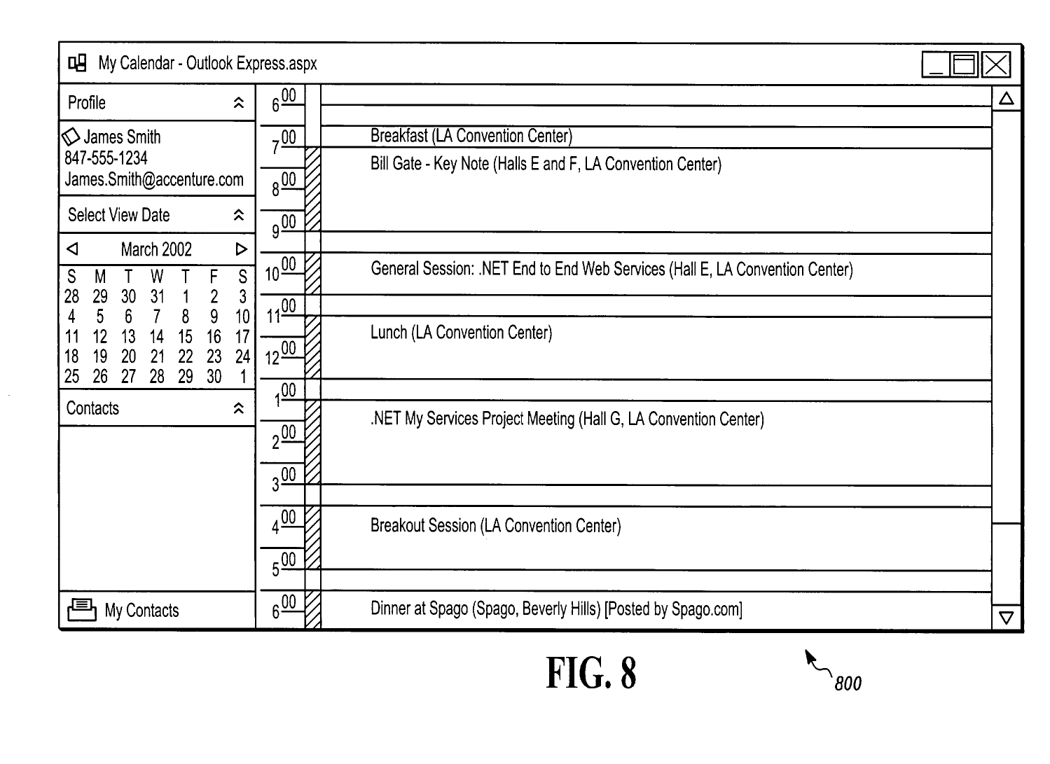

Assuming that the targeted recipient grants access at step 310 (for example, by clicking the “OK” button in FIG. 7), the dynamic service assistant accesses the targeted recipient's calendar at step 312 and, in response, receives schedule information for the targeted recipient at step 314. Schedule information in accordance with the present invention may be represented in virtually any manner. A particularly advantageous technique is to represent schedule information in a calendar form. An exemplary calendar display 800 is further illustrated in FIG. 8. Note that the schedule information received by the dynamic service assistant need not be represented in the visual form shown in FIG. 8 and, in practice, is represented in a more compact, machine-readable form, such as XML-encoded (Extensible Markup Language) data. In the instant example, it is assumed that the delivery service originally intended to deliver the package to the targeted recipient at 8:00 in the morning at the recipient's home. However, based on the schedule information illustrated in the calendar 800, the dynamic service assistant is able to determine that the targeted recipient will not be available to take delivery of the package.

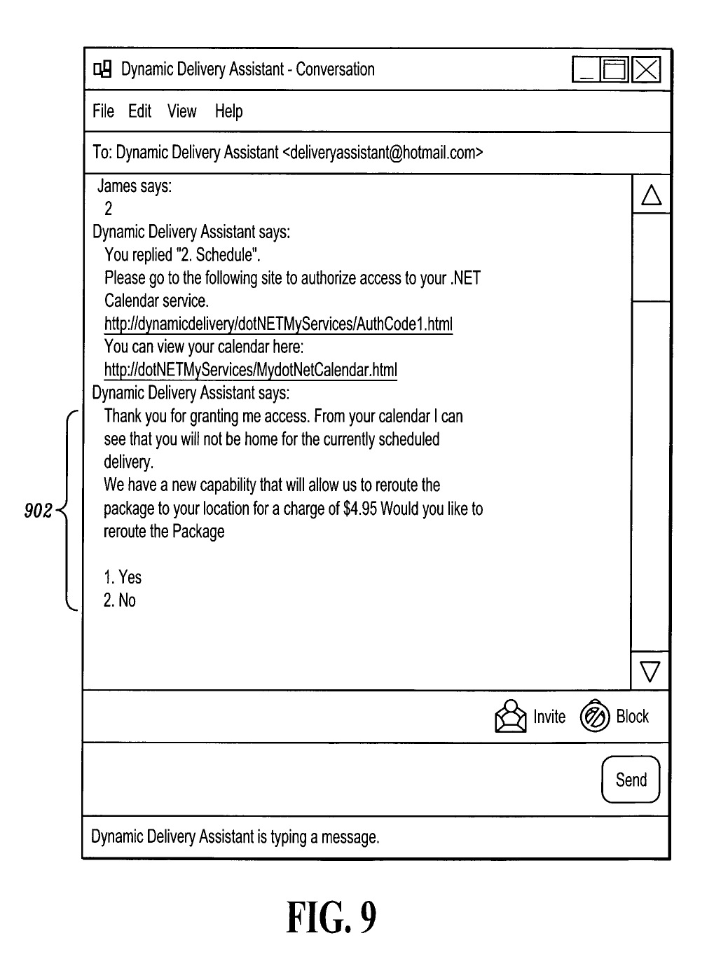

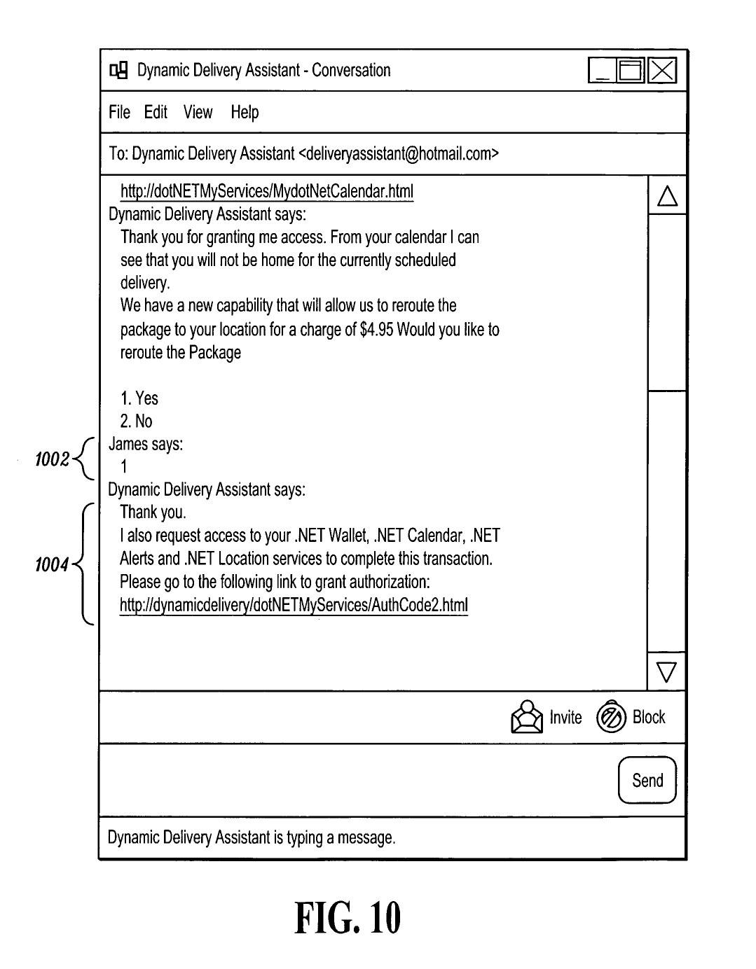

As a result, at step 316, the dynamic service assistant sends an offer to reschedule delivery for a fee to the targeted recipient. This is further illustrated in FIG. 9, as designated by reference numeral 902. In response, at step 318, and as further illustrated in FIG. 10 by reference numeral 1002, the targeted recipient transmits an indication of his or her willingness to reschedule delivery for the stated fee.

In response, at step 320, the dynamic service assistant sends a request to the targeted recipient requesting access to the targeted recipient's wallet, calendar, alerts and location services as illustrated in FIG. 10 by reference numeral 1004. Once again, the request to obtain access to the targeted recipient's information is presented as a URL pointing to a consent form, as further illustrated in FIG. 11. Using the consent form, at step 322, the targeted recipient is able to grant access to the targeted recipient's information to the dynamic service assistant.

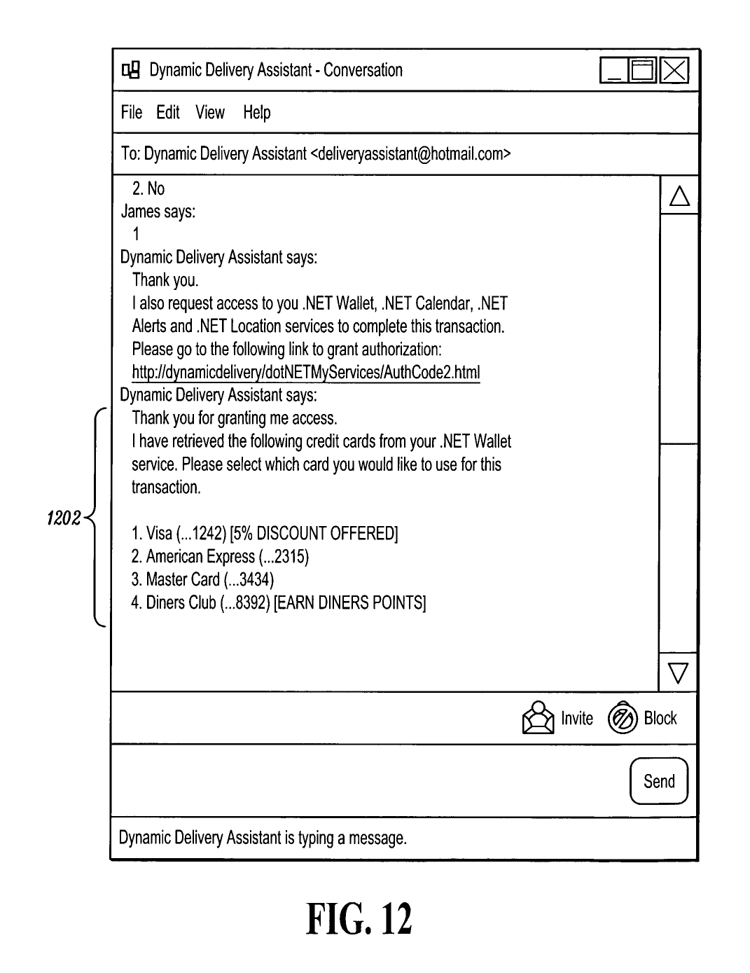

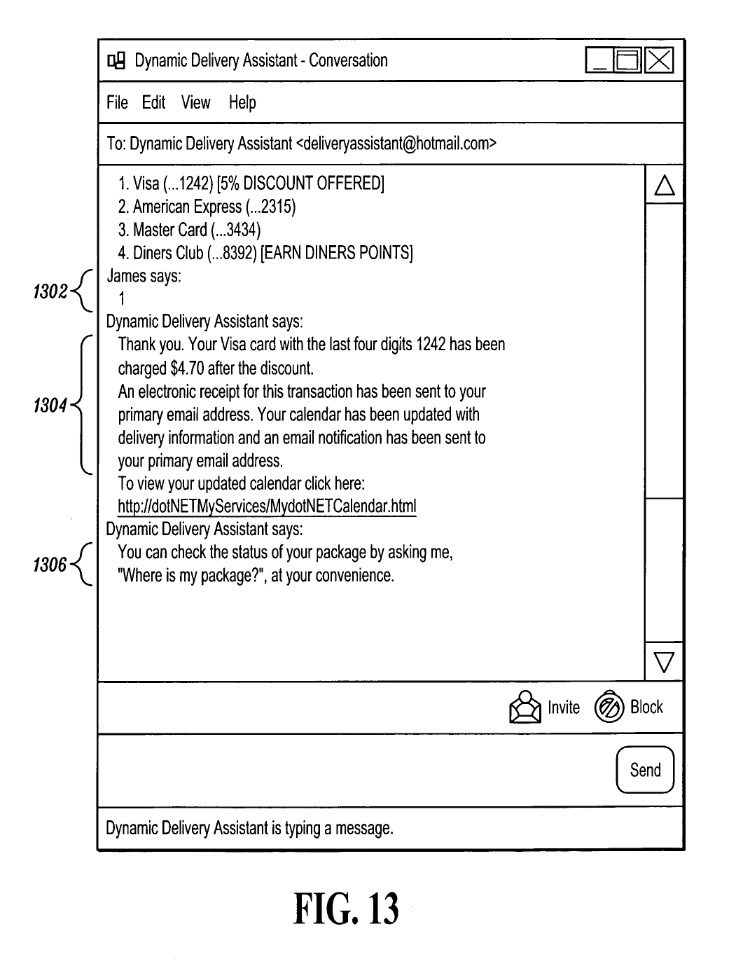

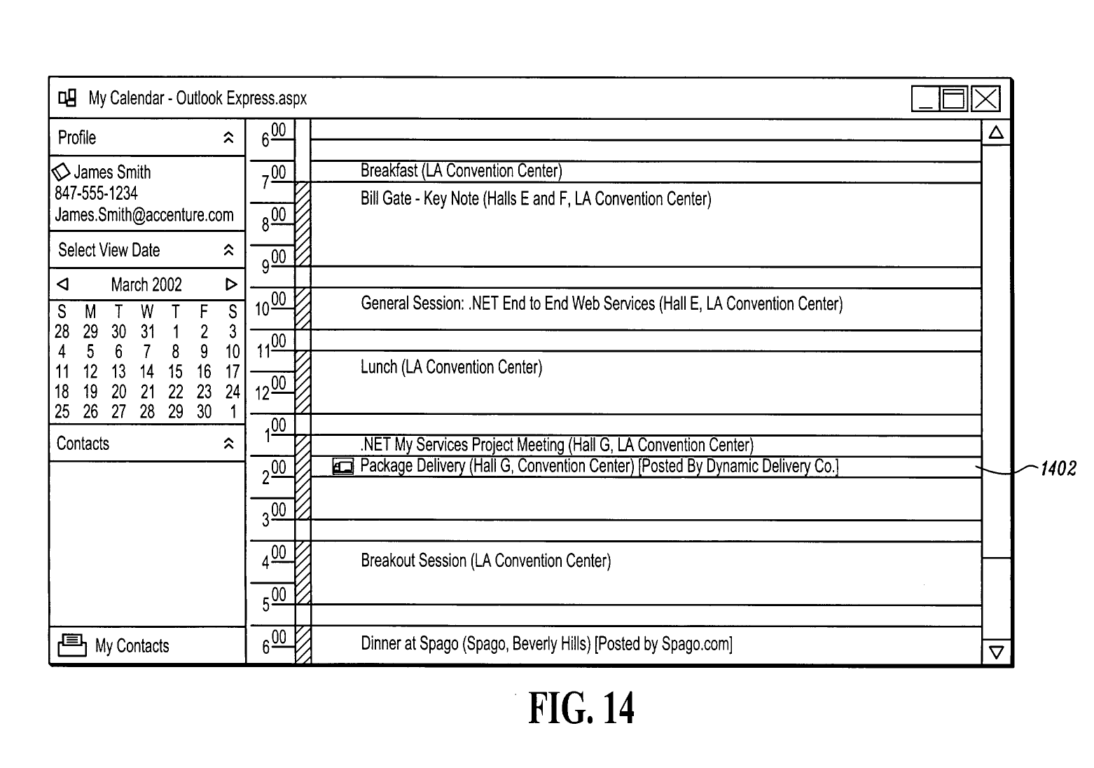

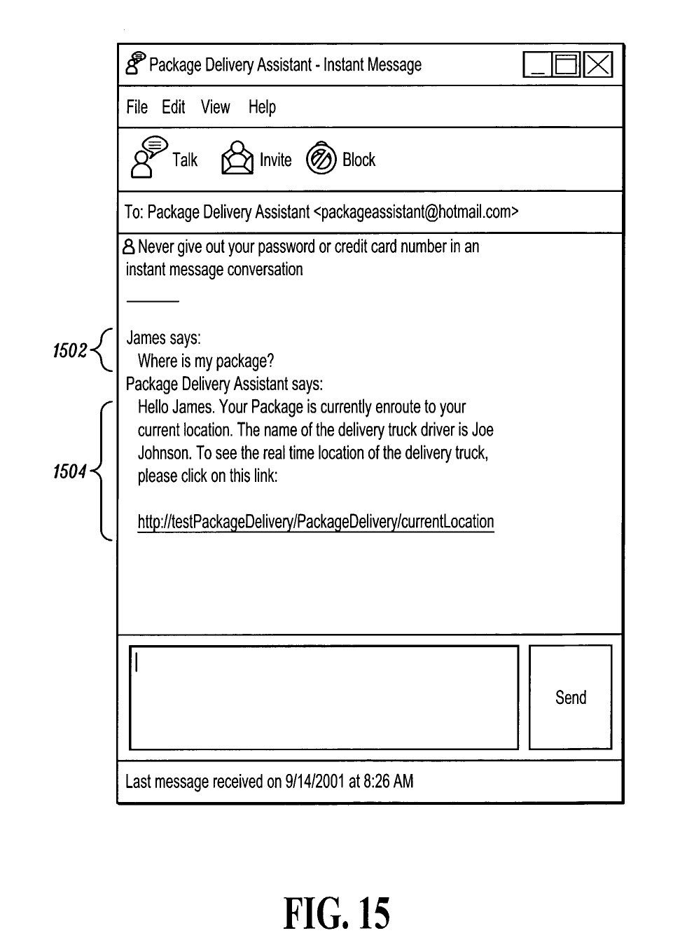

In the .NET My Services Platform, the so-called Wallet service acts as a central location for account information of the targeted recipient. Thus, at step 324, the dynamic service assistant accesses the information maintained by the targeted recipient's Wallet service and, at step 326, receives the account information pertaining to the targeted recipient. Based on the targeted recipient's account information, the dynamic service assistant, at step 328, presents payment options to the targeted recipient as further illustrated in FIG. 12 by reference numeral 1202. In response, at step 330, the targeted recipient selects a payment method, as illustrated in FIG. 13 by reference numeral 1302, and provides this selection information to the dynamic service assistant. Based on the selected payment method, the dynamic service assistant causes an appropriate debit to be made to the targeted recipient's wallet service at step 332. Additionally, at step 334, the dynamic service assistant schedules a delivery time based on the schedule information. Referring again to the example of FIG. 8, the dynamic service assistant determines that the targeted recipient will be available at a given location (in this case, Hall G of the L.A. Convention Center) during a window of time in which it would be convenient for the package delivery service to deliver a package to that location. As such, the dynamic delivery service automatically updates the targeted recipient's schedule information as illustrated in FIG. 14 by reference numeral 1402. Thereafter, at step 336, the dynamic service assistant sends a confirmation of the Wallet service transaction, as well as the update to the targeted recipient's calendar, to the targeted recipient. This is further illustrated in FIG. 13 by reference numeral 1304. As shown in FIG. 13, the dynamic delivery assistant, having access to the targeted recipient's Profile service, knows to send the confirmations to the targeted recipient's primary e-mail address. Additionally, as designated by reference numeral 1306, the dynamic delivery assistant provides the targeted recipient the opportunity to inquire as to the status of the package delivery by sending an appropriate status request. In this manner, at step 338, the targeted recipient sends a request for status of the package delivery as further illustrated in FIG. 15 by reference numeral 1502. In response, at step 340, the dynamic service assistant sends the requested status information to the targeted recipient. In this particular example, the dynamic delivery assistant provides a link which allows the targeted recipient to view real time location information of the delivery truck schedule to deliver the targeted recipient's package.

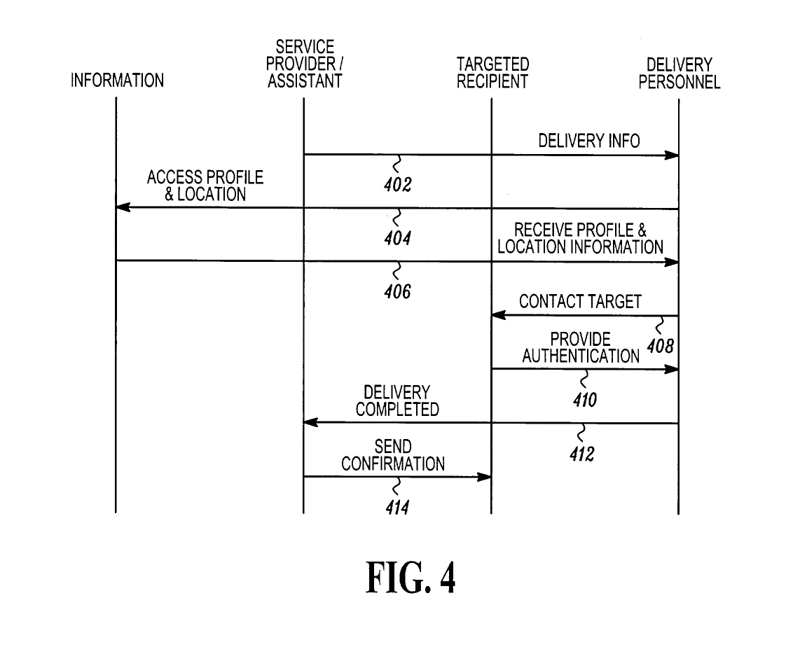

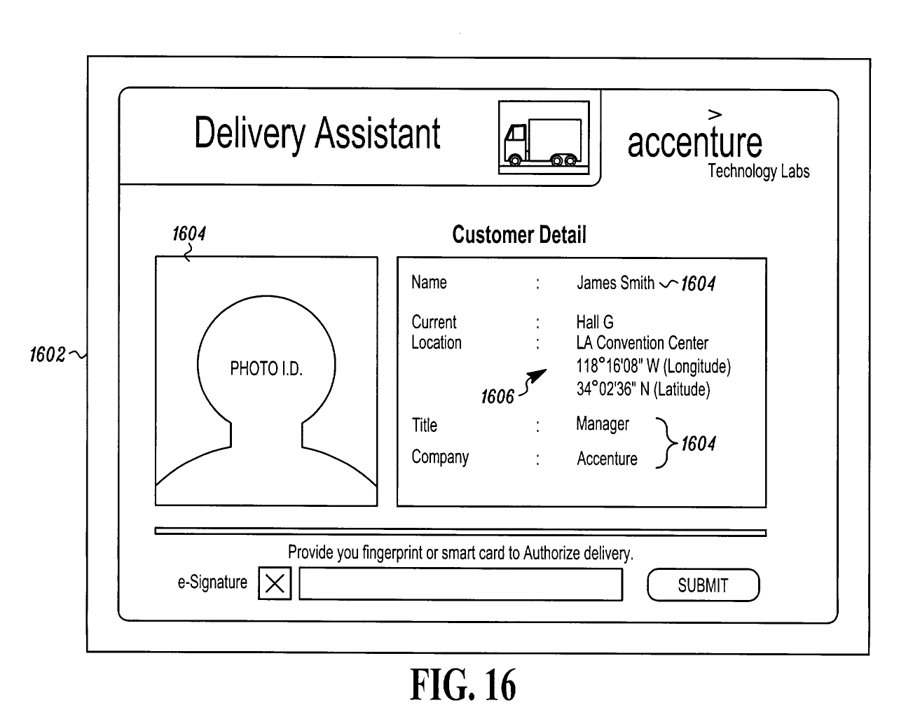

Referring now to FIG. 4, communications between the relevant parties when the package is to be delivered are further illustrated. Once again, the communications shown in FIG. 4 are preferably carried out using suitable computer-to-computer communication techniques and protocols. Thus, on or around the scheduled time of delivery, the service provider provides the desired package and delivery information, at step 402, to the delivery person. In this case, the delivery information comprises the agreed upon location and time for delivery of the package. At or before the time the delivery person arrives at the agreed upon location, he or she accesses the Profile and Location services of the targeted recipient as illustrated at step 404. Recall that access to the targeted recipient's profile and location services was previously granted at step 322. In response, at step 406, the delivery person receives the necessary profile and location information as to allow the delivery person to complete delivery of the package. This is further illustrated with reference to FIG. 16.

As shown in FIG. 16, the profile and location information may be displayed on a portable or wearable computer 1602 possessed by the delivery personnel. In the example shown, the profile information 1604 comprises an image of the targeted recipient's face (thereby facilitating visual identification of the targeted recipient) as well as other identifying information. Additionally, real-time or near real-time location information for the targeted recipient 1606 is also displayed. Based on this information, the delivery personnel, at step 408, is able to find and contact the targeted recipient. In response, at step 410, the targeted recipient provides authentication of his or her identity to the delivery personnel. As known in the art, such authentication can be provided in a variety of manners. For example, the targeted recipient could provide the delivery personnel with a driver's license or other form of conventional identification. In more sophisticated embodiments, biometric authentication may be used such a thumb print reader. Alternatively, other electronic identification means, such as a digital signature, may be used as known in the art. Regardless, once the delivery has been completed, the delivery personnel notifies the service provider at step 412 of the completed delivery. In response, the service provider, via the delivery assistant, sends confirmation of the delivery to the targeted recipient at step 414. Once again, in this manner, the present invention allows early detection of fraudulent delivery.

As described above, the present invention provides a technique for the dynamic fulfillment of services. To this end, the present invention utilizes permission-based access to schedule and other information maintained by the targeted recipient of the service to dynamically arrange fulfillment of the service. In a preferred embodiment, a dynamic service assistant is used to automate the process. In this manner, the present invention allows service providers to overcome many of the inefficiencies, and sources of customer dissatisfaction, encountered using prior art techniques.

In the foregoing specification, the present invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. For example, permissions described above could be granted for specific durations, rather than on a case-by-case basis. In this situation, for example, the targeted recipient could grant the necessary permissions once for a predetermined period of time. If, at the end of that predetermined period of time, additional time is required, the targeted recipient could agree to further extend the permissions for another predetermined period of time.

Additionally, it is assumed in the examples described above that the service provider has already established an intended delivery time and location when it first contacts the targeted recipient. However, in practice, this is not a necessity. In this regard, the dynamic service assistant could contact the targeted recipient prior to establishing any delivery time and location in order to schedule a time and place for fulfillment. In this manner, the service provider can get right to the recipient and schedule fulfillment without first attempting to establish its own time and place of fulfillment.

Further still, as described above, the service provider, via the dynamic service assistant, schedules a time and place for fulfillment based on the targeted recipient's schedule information. Thereafter, a confirmation of the scheduled fulfillment is sent to the targeted recipient. However, in practice, the targeted recipient's schedule may change thereby necessitating a further rescheduling or, upon receiving the confirmation of the scheduled fulfillment, the targeted recipient may realize that the scheduled fulfillment would be inappropriate or undesirable, e.g., receiving a package delivery in the middle of an important meeting. To this end, a mechanism may be employed that allows the targeted recipient to inform the service provider, preferably via the dynamic service assistant, of the targeted recipient's desire to reschedule fulfillment. In practice, this may be achieved by providing the targeted recipient, at the time the confirmation is sent, a URL, email address, phone number or other mechanism to contact the dynamic service assistant and request rescheduling. Because, in this case, the targeted recipient is specifically requesting rescheduling, it may be understood that the permissions to access the necessary information sources (e.g., the targeted recipient's calendar information) are being granted again, or that the previously granted permissions are still valid. Such rescheduling capability could be provided for additional fees, if desired. Regardless, allowing the targeted recipient to reschedule fulfillment provides an additional degree of flexibility while still retaining the benefits of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential features or elements of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. A computer-implemented method for fulfilling a service, the method comprising:
obtaining permission-based access to schedule information of a targeted recipient of the service; and
determining scheduled availability of the targeted recipient to accept fulfillment of the service based on the schedule information.

2. The method of claim 1, further comprising:
sending a notification to the targeted recipient of impending fulfillment of the service; and
receiving, in response to the notification, a response from the targeted recipient to schedule fulfillment of the service.

3. The method of claim 1, further comprising:
obtaining permission-based access to location information of the targeted recipient;
determining a location of the targeted recipient, based on the location information, substantially at a time of the scheduled availability of the targeted recipient; and
directing fulfillment of the service for the targeted recipient to the location.

4. The method of claim 3, further comprising:
charging the targeted recipient a fee for directing fulfillment of the service to the location.

5. The method of claim 4, further comprising:
obtaining permission-based access to account information of the targeted recipient,
wherein charging the targeted recipient further comprises obtaining the fee based on the account information.

6. The method of claim 1, wherein the service is delivery of an item to the targeted recipient.

7. A computer-implemented method for fulfilling a service, the method comprising:
obtaining permission-based access to location information of a targeted recipient of the service;
determining, based on the location information, a location of the targeted recipient; and
directing fulfillment of the service for the targeted recipient to the location.

8. The method of claim 7, further comprising:
sending a notification to the targeted recipient of impending fulfillment of the service; and
receiving, in response to the notification, a response from the targeted recipient to schedule fulfillment of the service.

9. The method of claim 7, further comprising:
obtaining permission-based access to schedule information of the targeted recipient; and
determining scheduled availability of the targeted recipient to accept the service based on the schedule information.

10. The method of claim 9, wherein determining the location of the targeted recipient further comprises:
determining the location of the targeted recipient substantially at a time of the scheduled availability of the targeted recipient.

11. The method of claim 7, further comprising:
charging the targeted recipient a fee for directing fulfillment of the service to the location.

12. The method of claim 11, further comprising:
obtaining permission-based access to account information of the targeted recipient,
wherein charging the targeted recipient further comprises obtaining the fee based on the account information.

13. The method of claim 7, wherein the service is delivery of an item to the targeted recipient.

14. A method for a targeted recipient of a service to assist in fulfillment of the service, the method comprising:
receiving, from a provider of the service via a communication device, a request to access schedule information of the targeted recipient; and
authorizing, via the communication device, access to the schedule information by the provider of the service,
wherein the provider determines scheduled availability of the targeted recipient to accept fulfillment of the service based on the schedule information.

15. The method of claim 14, further comprising:
receiving, from the provider via the communication device, a notification of impending fulfillment of the service; and
sending, via the communication device in response to the notification, a response to the provider to schedule fulfillment of the service.

16. The method of claim 14, further comprising:
receiving, from the provider via the communication device, a request to access location information of the targeted recipient; and
authorizing, via the communication device, access to the location information by the provider of the service,
wherein the provider determines a location of the targeted recipient, based on the location information, substantially at a time of the scheduled availability of the targeted recipient and directs fulfillment of the service for the targeted recipient to the location.

17. The method of claim 16, further comprising:
receiving, from the provider via the communication device, a request to access account information of the targeted recipient; and
authorizing, via the communication device, access to the account information by the provider of the service,
wherein the provider charges the targeted recipient a fee for directing fulfillment of the service to the location and obtains the fee based on the account information.

18. The method of claim 14, wherein the service is delivery of an item to the targeted recipient.

19. A method for a targeted recipient of a service to assist in fulfillment of the service, the method comprising:
receiving, from a provider of the service via a communication device, a request to access location information of the targeted recipient; and
authorizing, via the communication device, access to the location information by the provider of the service,
wherein the provider determines a location of the targeted recipient based on the location information and directs fulfillment of the service for the targeted recipient to the location.

20. The method of claim 19, further comprising:
receiving, from the provider via the communication device, a notification of impending fulfillment of the service; and
sending, via the communication device in response to the notification, a response to the provider to schedule fulfillment of the service.

21. The method of claim 19, further comprising:
receiving, from the provider via the communication device, a request to access schedule information of the targeted recipient; and
authorizing, via the communication device, access to the schedule information by the provider of the service,
wherein the provider determines scheduled availability of the targeted recipient to accept the service based on the schedule information.

22. The method of claim 19, further comprising:
receiving, from the provider via the communication device, a request to access account information of the targeted recipient; and
authorizing, via the communication device, access to the account information by the provider of the service,
wherein the provider charges the targeted recipient a fee for directing fulfillment of the service to the location and obtains the fee based on the account information.

23. The method of claim 19, wherein the service is delivery of an item to the targeted recipient.

24. A computer-readable medium having stored thereon computer-executable instructions for performing steps of:
obtaining permission-based access to schedule information of a targeted recipient of a service; and
determining scheduled availability of the targeted recipient to accept fulfillment of the service based on the schedule information.

25. The computer-readable medium of claim 24, further comprising computer-executable instructions for performing steps of:
sending a notification to the targeted recipient of impending fulfillment of the service; and
receiving, in response to the notification, a response from the targeted recipient to schedule fulfillment of the service.

26. The computer-readable medium of claim 24, further comprising computer-executable instructions for performing steps of:
obtaining permission-based access to location information of the targeted recipient;
determining a location of the targeted recipient, based on the location information, substantially at a time of the scheduled availability of the targeted recipient; and
directing fulfillment of the service for the targeted recipient to the location.

27. The computer-readable medium of claim 26, further comprising computer-executable instructions for performing steps of:
obtaining permission-based access to account information of the targeted recipient; and
charging the targeted recipient a fee, based on the account information, for directing fulfillment of the service to the location.

28. A server computer comprising the computer-readable medium of claim 24.

29. A computer-readable medium having stored thereon computer-executable instructions for performing steps of:
obtaining permission-based access to location information of a targeted recipient of a service;
determining, based on the location information, a location of the targeted recipient; and
directing fulfillment of the service for the targeted recipient to the location.

30. The computer-readable medium of claim 29, further comprising computer-executable instructions for performing steps of:
sending a notification to the targeted recipient of impending fulfillment of the service; and
receiving, in response to the notification, a response from the targeted recipient to schedule fulfillment of the service.

31. The computer-readable medium of claim 29, further comprising computer-executable instructions for performing steps of:
obtaining permission-based access to schedule information of the targeted recipient; and
determining scheduled availability of the targeted recipient to accept the service based on the schedule information.

32. The computer-readable medium of claim 29, further comprising computer-executable instructions for performing steps of:
obtaining permission-based access to account information of the targeted recipient; and
charging the targeted recipient a fee, based on the account information, for directing fulfillment of the service to the location.

33. A server computer comprising the computer-readable medium of claim 29.

34. A computer-readable medium having stored thereon computer-executable instructions for performing steps of:
receiving, from a provider of a service, a request to access schedule information of a targeted recipient of the service; and
authorizing access to the schedule information by the provider of the service,
wherein the provider determines scheduled availability of the targeted recipient to accept fulfillment of the service based on the schedule information.

35. The computer-readable medium of claim 34, further comprising computer-executable instructions for performing steps of:
receiving, from the provider, a notification of impending fulfillment of the service; and
sending, in response to the notification, a response to the provider to schedule fulfillment of the service.

36. The computer-readable medium of claim 34, further comprising computer-executable instructions for performing steps of:
receiving, from the provider, a request to access location information of the targeted recipient; and
authorizing access to the location information by the provider of the service,
wherein the provider determines a location of the targeted recipient, based on the location information, substantially at a time of the scheduled availability of the targeted recipient and directs fulfillment of the service for the targeted recipient to the location.

37. The computer-readable medium of claim 36, further comprising computer-executable instructions for performing steps of:
receiving, from the provider, a request to access account information of the targeted recipient; and
authorizing access to the account information by the provider of the service,
wherein the provider charges the targeted recipient a fee for directing fulfillment of the service to the location and obtains the fee based on the account information.

38. A communication device comprising the computer-readable medium of claim 34.

39. A computer-readable medium having stored thereon computer-executable instructions for performing steps of:
receiving, from a provider of a service, a request to access location information of a targeted recipient of the service; and
authorizing access to the location information by the provider of the service,
wherein the provider determines a location of the targeted recipient based on the location information and directs fulfillment of the service for the targeted recipient to the location.

40. The computer-readable medium of claim 39, further comprising computer-executable instructions for performing steps of:
receiving, from the provider, a notification of impending fulfillment of the service; and
sending, in response to the notification, a response to the provider to schedule fulfillment of the service.

41. The computer-readable medium of claim 39, further comprising computer-executable instructions for performing steps of:
receiving, from the provider, a request to access schedule information of the targeted recipient; and
authorizing access to the schedule information by the provider of the service,
wherein the provider determines scheduled availability of the targeted recipient to accept the service based on the schedule information.

42. The computer-readable medium of claim 39, further comprising computer-executable instructions for performing steps of:
receiving, from the provider, a request to access account information of the targeted recipient; and
authorizing access to the account information by the provider of the service,
wherein the provider charges the targeted recipient a fee for directing fulfillment of the service to the location and obtains the fee based on the account information.

43. A communication device comprising the computer-readable medium of claim 39.

44. A server computer, in communication with a targeted recipient of a service, for use in fulfilling the service, the server computer comprising:
means for obtaining permission-based access to schedule information of a targeted recipient of a service; and
means for determining scheduled availability of the targeted recipient to accept fulfillment of the service based on the schedule information.

45. The server computer of claim 44, further comprising:
means for sending a notification to the targeted recipient of impending fulfillment of the service; and
means for receiving, in response to the notification, a response from the targeted recipient to schedule fulfillment of the service.

46. The server computer of claim 45, further comprising:
means for obtaining permission-based access to location information of the targeted recipient;
means for determining a location of the targeted recipient, based on the location information, substantially at a time of the scheduled availability of the targeted recipient; and
means for directing fulfillment of the service for the targeted recipient to the location.

47. The server computer of claim 46, further comprising:
means for obtaining permission-based access to account information of the targeted recipient; and
means for charging the targeted recipient a fee, based on the account information, for directing fulfillment of the service to the location.

48. A server computer, in communication with a targeted recipient of a service, for use in fulfilling the service, the server computer comprising:
means for obtaining permission-based access to location information of a targeted recipient of a service;
means for determining, based on the location information, a location of the targeted recipient; and
means for directing fulfillment of the service for the targeted recipient to the location.

49. The server computer of claim 48, further comprising:
means for sending a notification to the targeted recipient of impending fulfillment of the service; and
means for receiving, in response to the notification, a response from the targeted recipient to schedule fulfillment of the service.

50. The server computer of claim 48, further comprising:
means for obtaining permission-based access to schedule information of the targeted recipient; and
means for determining scheduled availability of the targeted recipient to accept the service based on the schedule information.

51. The server computer of claim 48, further comprising:
means for obtaining permission-based access to account information of the targeted recipient; and
means for charging the targeted recipient a fee, based on the account information, for directing fulfillment of the service to the location.

52. A communication device, in communication with a provider of a service, for use by a targeted recipient of the service in fulfilling the service, the communication device comprising:
means for receiving, from the provider, a request to access schedule information of the targeted recipient; and
means for authorizing access to the schedule information by the provider of the service,
wherein the provider determines scheduled availability of the targeted recipient to accept fulfillment of the service based on the schedule information.

53. The communication device of claim 52, further comprising:
means for receiving, from the provider, a notification of impending fulfillment of the service; and
means for sending, in response to the notification, a response to the provider to schedule fulfillment of the service.

54. The communication device of claim 52, further comprising:
means for receiving, from the provider, a request to access location information of the targeted recipient; and
means for authorizing access to the location information by the provider of the service,
wherein the provider determines a location of the targeted recipient, based on the location information, substantially at a time of the scheduled availability of the targeted recipient and directs fulfillment of the service for the targeted recipient to the location.

55. The communication device of claim 54, further comprising:
means for receiving, from the provider, a request to access account information of the targeted recipient; and
means for authorizing access to the account information by the provider of the service,
wherein the provider charges the targeted recipient a fee for directing fulfillment of the service to the location and obtains the fee based on the account information.

56. A communication device, in communication with a provider of a service, for use by a targeted recipient of the service in fulfilling the service, the communication device comprising:
means for receiving, from the provider, a request to access location information of the targeted recipient; and
means for authorizing access to the location information by the provider of the service,
wherein the provider determines a location of the targeted recipient based on the location information and directs fulfillment of the service for the targeted recipient to the location.

57. The communication device of claim 56, further comprising:
means for receiving, from the provider, a notification of impending fulfillment of the service; and
means for sending, in response to the notification, a response to the provider to schedule fulfillment of the service.

58. The communication device of claim 56, further comprising:
means for receiving, from the provider, a request to access schedule information of the targeted recipient; and
means for authorizing access to the schedule information by the provider of the service,
wherein the provider determines scheduled availability of the targeted recipient to accept the service based on the schedule information.

59. The communication device of claim 56, further comprising:
means for receiving, from the provider, a request to access account information of the targeted recipient; and
means for authorizing access to the account information by the provider of the service,
wherein the provider charges the targeted recipient a fee for directing fulfillment of the service to the location and obtains the fee based on the account information.

60. A method for delivering an item to a targeted recipient, the method comprising:
notifying the targeted recipient of impending delivery of the item;
requesting permission to access schedule information of the targeted recipient;
receiving permission to access the schedule information of the targeted recipient; and
determining, based on the schedule information, availability of the targeted recipient to take delivery of the item at an intended delivery time at an intended delivery location.

61. The method of claim 60, further comprising:
determining, based on the schedule information, that the targeted recipient will not be available during the intended delivery time at the intended delivery location; and
rescheduling, based on the schedule information, delivery of the item to the targeted recipient at a scheduled time and a scheduled location.

62. The method of claim 61, further comprising:
in response to determining that the targeted recipient will not be available during the intended delivery time at the intended delivery location, sending, to the targeted recipient, an offer to reschedule delivery of the item; and
receiving, from the targeted recipient in response to the offer to reschedule delivery, a request to reschedule delivery of the item.

63. The method of claim 62, wherein the offer to reschedule delivery includes notification of a fee to reschedule delivery, the method further comprising:
requesting permission to access account information of the targeted recipient in order to obtain payment of the fee;
receiving permission to access the account information of the targeted recipient; and
obtaining payment of the fee based on the account information of the targeted recipient.

64. The method of claim 61, further comprising:
updating the schedule information of the targeted recipient with the scheduled time and the scheduled location.

65. The method of claim 61, further comprising:
notifying the targeted recipient of the scheduled time and the scheduled location.

66. The method of claim 61, further comprising:
at the scheduled time and scheduled location, accessing location information and identification information of the targeted recipient; and
delivering the item to the targeted recipient based on the location information and the identification information of the intended recipient.

67. The method of claim 66, wherein delivering the item further comprises authenticating identification of the targeted recipient.

68. The method of claim 60, further comprising:
receiving, from the targeted recipient, a delivery status request from the targeted recipient; and
providing status information regarding delivery of the item to the targeted recipient based on an identification of the targeted recipient and in response to the delivery status request.

69. A method for facilitating delivery of an item to a targeted recipient by a delivery person, the method comprising:
at a scheduled time and at a scheduled location of delivery of the item, accessing, by the delivery person, real-time location information of the targeted recipient; and
delivering the item to the targeted recipient based on the location information of the targeted recipient.

70. The method of claim 69, further comprising, prior to delivering the item:
electronically verifying identification of the targeted recipient.

71. A method for facilitating delivery of an item to a targeted recipient by a delivery person, the method comprising:
at a scheduled time and at a scheduled location of delivery of the item, accessing, by the delivery person, identification information of the targeted recipient that facilitates visual identification of the targeted recipient; and
delivering the item to the targeted recipient based on the identification information of the targeted recipient.

72. The method of claim 70, further comprising, prior to delivering the item:
electronically verifying identification of the targeted recipient.
